(19) United States
(12) Patent Application Publication
(10) Pub. No.: US 2017/0149365 A1
(43) Pub. Date: May 25, 2017

(54) METHOD OF OPERATING AN ELECTRIC MOTOR

(71) Applicant: AUDI AG, 85045 lngolstadt (DE)

(72) Inventor: JOSEF BURGER, Seubersdorf (DE)

(73) Assignee: AUDI AG, 85045 lngolstadt (DE)

(21) Appl. No.: 15/355,938

(22) Filed: Nov. 18, 2016

(30) Foreign Application Priority Data
Nov. 21, 2015 (DE) 10 2015 015 131.2

(51) Int. Cl. H02P 7/29; G05B 19/02; H02P 31/00

(52) U.S. Cl. CPC H02P 7/29; H02P 31/00; G05B 19/02; H02P 2209/11

(57) ABSTRACT

In a method of operating an electric motor, a pulse-width-modulated basic signal having a pulse width modulation frequency is generated for an electric variable of the electric motor. A control unit generates for the electric variable a sinusoidal additional signal at a sinusoidal frequency in an acoustically audible frequency range, and adds the basic signal and the additional signal to form an acoustic signal for the electric variable. The electric variable with the acoustic signal can be made available to the electric motor.

### CROSS-REFERENCES TO RELATED APPLICATIONS

This application claims the priority of German Patent Application, Serial No. 10 2015 015 131.2, filed Nov. 21, 2015, pursuant to 35 U.S.C. 119(a)-(d), the disclosure of which is incorporated herein by reference in its entirety as if fully set forth herein.

### BACKGROUND OF THE INVENTION

The present invention relates to a method of operating an electric motor.

The following discussion of related art is provided to assist the reader in understanding the advantages of the invention, and is not to be construed as an admission that this related art is prior art to this invention.

When generating an acoustic signal is involved, the use of a loudspeaker or buzzer is normally contemplated.

It would be desirable and advantageous to obviate prior art shortcomings.

### SUMMARY OF THE INVENTION

According to one aspect of the present invention, a method of operating an electric motor includes generating for an electric variable of the electric motor a pulse-width-modulated basic signal having a pulse width modulation frequency, generating for the electric variable a sinusoidal additional signal at a sinusoidal frequency in an acoustically audible frequency range, adding the basic signal and the additional signal to form an acoustic signal for the electric variable, and making the electric variable with the acoustic signal available to the electric motor.

According to another advantageous feature of the present invention, the sinusoidal frequency can be selected smaller than the pulse width modulation frequency. The sinusoidal frequency has typically in the audible range a value ranging from infrasound frequencies of few Hertz up to ultrasound frequencies of about 20,000 Hz. It is hereby possible to select and set a precise value of the frequency suited to the user. The pulse width modulation frequency normally amounts to at least few thousand Hz, e.g. at least 10,000 Hz or 20,000 Hz.

A method according to the present invention can be executed for an electric motor which is part of a component and/or part of a device, normally a technical facility.

According to another advantageous feature of the present invention, the electric variable with the acoustic signal can be fed to the electric motor in the presence of a defined operating state of at least one component of the device, i.e. for the electric motor and/or at least a further component of the device. The value of the sinusoidal frequency may hereby be adjusted as a function of the type of the operating state. When executing the method according to the invention for various operating states, a distinct sinusoidal frequency can be adjusted for each of these operating states.

According to another advantageous feature of the present invention, the component of the device and, optionally, the device as a whole can be moved with the electric motor.

The device may involve a motor vehicle. The motor vehicle is hereby moved with the electric motor and thus powered. As an alternative, or in addition, it is also possible to operably connect the electric motor to a component of the motor vehicle and thus to move the component. Such a component is, e.g. configured as a closing element of, e.g., a door, gate, or window pane, or opening of a vehicle body.

According to another advantageous feature of the present invention, at least one sensor can be associated to the device and/or involves a component of the device for monitoring an operating parameter of the at least one component of the device. The method according to the present invention can then be executed, when for at least one operating parameter a value is encountered which indicates the defined operating state. The presence of such a sensor may, however, be omitted.

A modulation within the scope of the method according to the invention can be executed for the entire or complete basic signal.

According to another advantageous feature of the present invention, a duty factor or control factor of the pulse width modulation frequency can be varied. A ratio of a duration of a pulse of the pulse width modulation to a duration of a period of the pulse width modulation can hereby be modified.

As an alternative or in addition, a pulse width and thus duration of the pulse of the pulse width modulation can be varied.

A method according to the present invention can be carried out for an electric motor which is configured as servo drive.

According to another aspect of the present invention, a system for operating an electric motor includes an electric variable generated by a pulse-width-modulated basic signal having a pulse width modulation frequency, a control unit (ECU) configured to generate for the electric variable of the electric motor a sinusoidal additional signal at a sinusoidal frequency in an acoustically audible frequency range, to add the basic signal and the additional signal to form an acoustic signal for the electric variable, and to make the electric variable with the acoustic signal available to the electric motor.

According to another advantageous feature of the present invention, the control unit can be configured to generate the pulse-width-modulated basic signal. The control unit may hereby not only execute a method according to the present invention but also assume other functions. When used in a motor vehicle which is already equipped with a control unit, this control unit can now be used for the purpose of executing the method according to the present invention, and, optionally, also for further functions of the electric motor and/or other devices of the motor vehicle.

According to another advantageous feature of the present invention, the control unit can be accommodated in a housing of the electric motor and may be used for controlling other functions of the electric motor.

According to another advantageous feature of the present invention, the control unit can include a bridge circuit which can also be used for generating the acoustic signal. The bridge circuit may involve a so-called H-bridge. The pulse-width-modulated basic signal and the additional signal may be added upstream or downstream of the bridge circuit. Addition may involve digital addition. The resultant acoustic signal for the electrical variable can be made available from the bridge circuit to the electric motor. As an alternative, it is also possible for the pulse-width-modulated basic signal to run through the bridge circuit and then to add the additional signal, e.g. analogously, to provide the resultant acoustic signal for the electrical variable to the electric motor.

According to another advantageous feature of the present invention, a sensor can be operatively connected to a component of a device for monitoring an operating parameter of the component. The system is configured to execute the afore-described method according to the present invention, when the operating parameter has a value that indicates the presence of a defined operating state of the component.

The electrical variable may involve, for example, a voltage applied to the electric motor or a current flowing through the electric motor.

A method according to the present invention and a system according to the present invention enables the use of an electric motor and thus of an electric drive to generate an audible acoustic signal. This requires merely the use of the electric motor and the control unit which both already exist in the device. There is no need for an additional module, e.g. a loudspeaker, a diaphragm, a flap, or buzzer. Thus, the electric motor, configured as servo drive for example, can be used to spontaneously generate the acoustic signal, without additional module, so that weight and installation space can be saved in connection of its use in a motor vehicle.

It is thus possible for example to generate a warning signal by using the acoustic signal, when the at least one component of the device assumes a specific operating state. This may involve, for example, an automatic hatchback of a motor vehicle as component which can be moved back and forth by an electric motor configured as servo drive so as to open and close. The acoustic signal may, e.g., be generated, when the hatchback undergoes a training run as possible operating state. As an alternative or in addition, the acoustic signal is generated by the electric motor, when the hatchback is exposed to an external force to cause the hatchback to assume again a defined operating state. Furthermore, it is possible for the electric motor, configured as servo drive for the hatchback, to spontaneously generate the acoustic signal as warning signal in response to a foreign impact upon the hatchback.

A method according to the present invention can be executed also for a motor vehicle as device, having an electric motor for propulsion thereof. The acoustic signal generated by the electric motor can hereby be used to produce an engine sound.

In order to generate the acoustic signal through addition of the basic signal and the additional signal, the pulse width modulation frequency of the basic signal to activate the electric motor, is superimposed with the sinusoidal frequency in the audible range. As a result, a pitch and/or level of the audible acoustic signal can be influenced.

The acoustic signal generated by a method according to the present invention is gentle for the electric motor. Moreover, the acoustic signal can be modulated by varying the duty factor or mark-to-space ratio for the pulse-width-modulated basic signal. Furthermore, as an alternative or in addition, modulation of an amplitude or frequency of the basic signal is possible before being added with the additional signal to form the acoustic signal.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1a is a schematic representation of a first embodiment of a system to execute a method according to the present invention;

FIG. 1b is a flow diagram of making an acoustic signal in accordance with the present invention;

FIG. 1c is a graphical illustration showing a course of an acoustic signal generated by the system of FIGS. 1a and 1b;

FIG. 2 is a schematic representation of a second embodiment of a system to execute a method according to the present invention;

FIG. 2a is a graphical illustration of an acoustic signal generated by the system of FIG. 2;

FIG. 2b is a graphical illustration of a course of an acoustic, signal generated by the system of FIG. 2a, depicting the relationship between time along the abscissa and amplitude along the ordinate; and

FIG. 2c is a graphical illustration of a detail of the acoustic signal of FIG. 2b.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

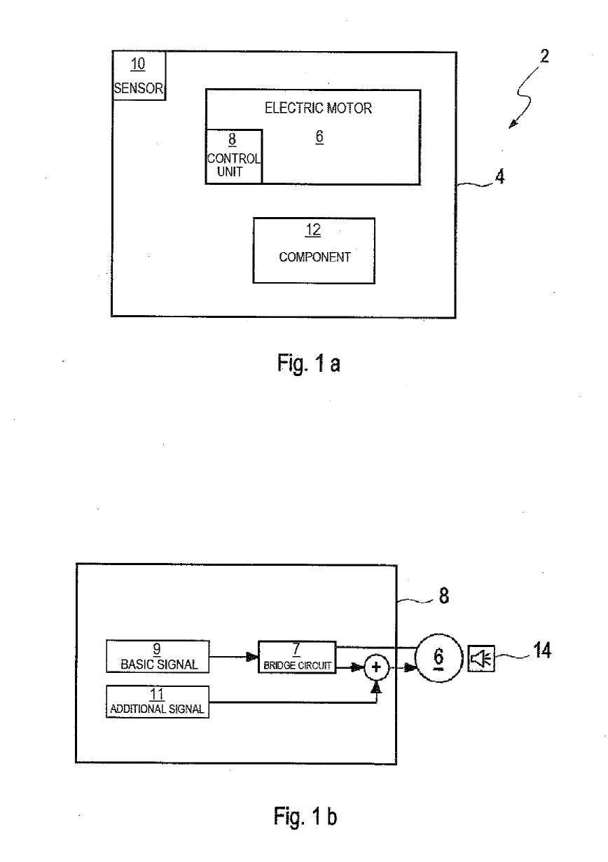

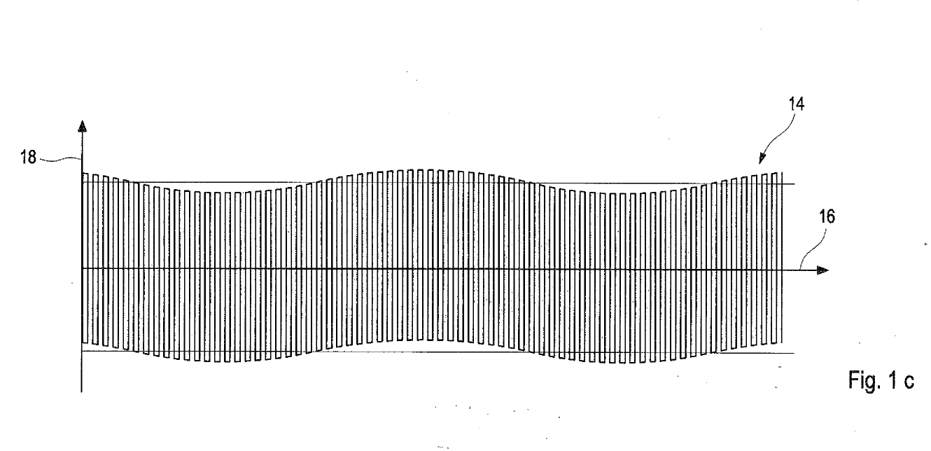

Turning now to the drawing, and in particular to FIG. 1a, there is shown a schematic representation of a first embodiment of a system, generally designated by reference numeral 2 to execute a method according to the present invention in a motor vehicle as an example for a technical device 4. The system 3 includes an electric motor 6 as electric drive, a control unit 8, shown here by way of example as being part of the electric motor 6, and an optional sensor 10 for use for control purposes. The motor vehicle has a component 12, e.g. a flap, which is to be moved by the electric motor 6.

FIG. 1b shows a flow diagram of making an acoustic signal in accordance with the present invention. As is readily apparent, the control unit 8 includes a bridge circuit 7. In addition, a pulse-width-modulated basic signal 9 is generated, which has a pulse-width-modulated square-wave clock pulse, and an additional signal 11 is generated which is configured as sine signal.

During operation of the electric motor 6, which is configured here by way of example as a servo drive, the pulse-width-modulated basic signal 9 is generated by the control unit 8 for an electric variable by which the electric motor 6 is activated, with the electric energy, made available via the basic signal 9, being converted by the electric motor 6 into mechanical energy that in turn causes a movement the component 12. The basic signal 9 has here a constant amplitude.

As the method according to the invention is executed, the optional sensor 10 ascertains a defined operating state of the component 12. When the sensor 10 detects that the component 12 has assumed the defined operating state, the control unit 8 adds the basic signal 9 and the additional signal 11 downstream of the bridge circuit 7 to form an acoustic signal 14 which can be outputted by the electric motor 6. FIG. 1c shows hereby a graphical illustration of the acoustic signal 14 generated by the system 2, with an abscissa 16 representing the time, and an ordinate 18 representing the values of the electric variable, e.g. a voltage, with the electrical variable being made available to the electric motor 6 with the and/or via the acoustic signal 14. Thus, the acoustic signal 14 is generated by supplementing the pulse-width-modulated basic signal 9 for the electric motor 6, which basic signal 9 has a pulse width modulation frequency, with the sinusoidal additional signal 11 that has a sinusoidal frequency in an acoustically audible frequency range. The basic signal 9 and the additional signal 11 are added to form the acoustic signal 14 for the electric variable, which in turn is made available to the electric motor 6.

As shown in FIG. 1b, the pulse-width-modulated basic signal 9 is fed to the bridge circuit 7 of the control unit 8. The additional signal 11 is added here, by way of example, to the basic signal 9 after the bridge circuit 7. The acoustic signal resulting from the addition of the basic signal 9 and the additional signal 11 is fed to the electric motor 6 which causes a movement in response to the respective operating state on the basis of the provided basic signal 9 and outputs the acoustic signal 14 on the basis of the provided additional signal 11. Provision is hereby made to add the basic signal 9 and the additional signal 11 in an analogous manner.

As is readily apparent from FIG. 1c, the acoustic signal 14 includes the pulse-width-modulated and rectangular basic signal 9 which fully oscillates at the sinusoidal frequency in response to the addition with the additional signals 11, with the amplitude of the basic signal 9 of the pulse width modulation being modulated in a sinusoidal manner when supplemented with the additional signal 11.

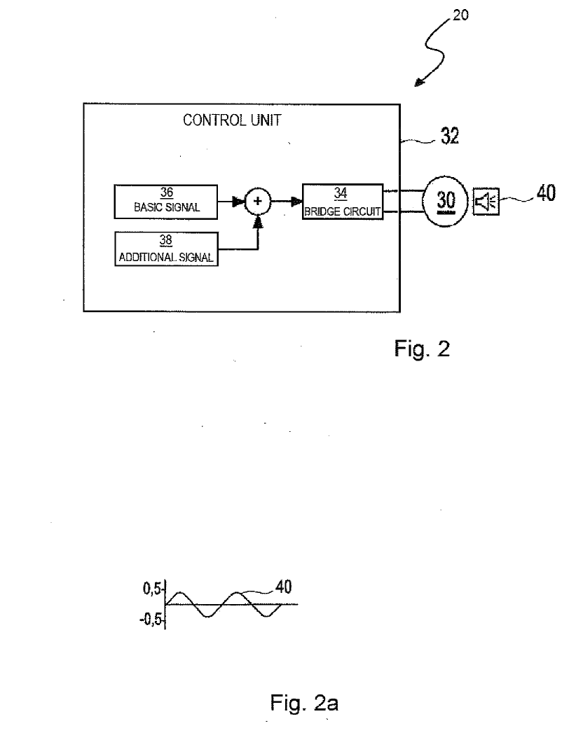

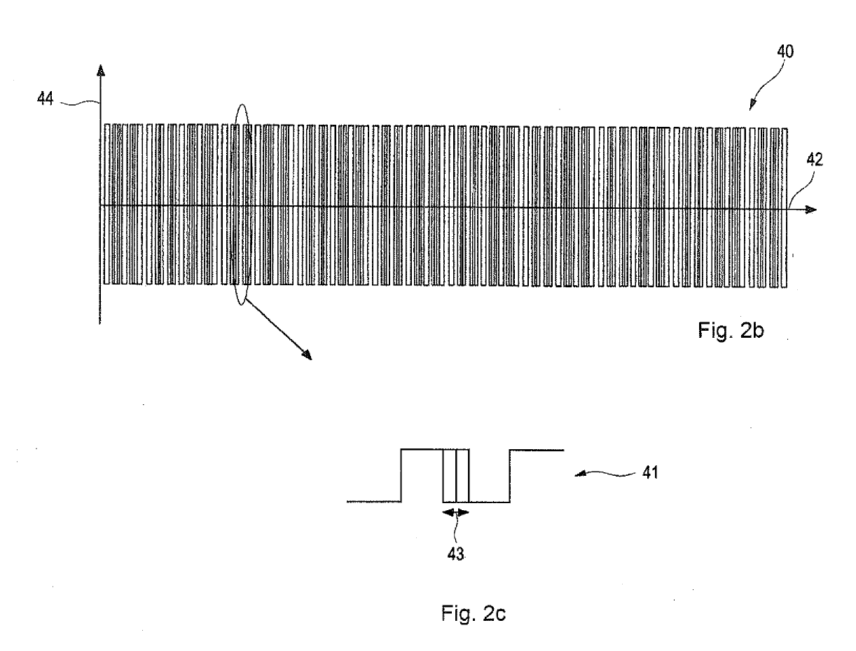

Turning now to FIG. 2, there is shown a schematic representation of a second embodiment of a system, generally designated by reference numeral 20, for executing a method according to the present invention. The system 20 includes an electric motor 30 which is configured as servo drive and operatively connected to a control unit 32 configured to control at least one function of the electric motor 30 independently from the execution of the method according to the present invention. The control unit 32 has a bridge circuit 34 in the form of a H-bridge. During normal operation, the electric motor 30 is activated via a pulse-width-modulated basic signal 36 for an electric variable and thereby caused to move. The basic signal 36 has a typical pulse width modulation frequency, with the basic signal 36 of the pulse width modulation and/or pulse width modulation frequency being dependent, i.a., on a duty factor.

In accordance with the present invention, a sinusoidal additional signal 38 is generated with a sinusoidal frequency in an acoustically audible frequency range. The basic signal 36 for the electrical variable, configured by way of example as current or voltage, and the additional signal 38 are added upstream of the bridge circuit 34 and transmitted to the electric motor 30 via the bridge circuit 34. In response to the basic signal 36, the electric motor 30 carries out a movement provided for a respective operating state and generates in response to the provided additional signal 38 an acoustic signal 40 for the electrical variable. FIG. 2a shows a graphical illustration of the acoustic signal 40 having a frequency of 10 kHz.

FIG. 2b is a graphical illustration of a course of an acoustic signal generated by the electric motor 30, with an abscissa 42 representing the time in milliseconds, and an ordinate 44 representing an amplitude of the electric variable. FIG. 2c shows a detail 41 of the acoustic signal 40. Reference numeral 43 designates in FIG. 2c the manner by which a width of a flank position of a square-wave pulse of the acoustic signal 40 is varied. It is hereby possible to vary the width of the flank position while a duty factor of the basic signal 36 is varied. In accordance with the present invention, the electric motor 30 can be provided with the electric variable together with the acoustic signal 49, with the electric motor 30 generating the acoustic signal 40 during operation.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method of operating an electric motor, comprising:
generating for an electric variable of the electric motor a pulse-width-modulated basic signal having a pulse width modulation frequency;
generating for the electric variable a sinusoidal additional signal at a sinusoidal frequency in an acoustically audible frequency range;
adding the basic signal and the additional signal to form an acoustic signal for the electric variable; and
making the electric variable with the acoustic signal available to the electric motor.

2. The method of claim 1, wherein the sinusoidal frequency is smaller than the pulse width modulation frequency.

3. The method of claim 1, wherein the electric motor is part of a device.

4. The method of claim 3, wherein the electric variable with the acoustic signal is made available to the electric motor in the presence of a defined operating state of at least one component of the device.

5. The method of claim 4, further comprising moving the component of the device with the electric motor.

6. The method of claim 3, wherein the device is a motor vehicle.

7. The method of claim 1, further comprising varying a duty factor of the pulse width modulation frequency.

8. The method of claim 1, further comprising varying a pulse duration of the pulse width modulation frequency.

9. The method of claim 1, wherein the electric motor is configured as servo drive.

10. A system for operating an electric motor; comprising:
an electric variable generated by a pulse-width-modulated basic signal having a pulse width modulation frequency; and
a control unit configured to generate for the electric variable of the electric motor a sinusoidal additional signal at a sinusoidal frequency in an acoustically audible frequency range, to add the basic signal and the additional signal to form an acoustic signal for the electric variable, and to make the electric variable with the acoustic signal available to the electric motor.

11. The system of claim 10, wherein the control unit is configured to generate the pulse-width-modulated basic signal.

12. The system of claim 10, further comprising a housing, said control unit being accommodated in the housing.

13. The system of claim 10, wherein the control unit includes a bridge circuit, with the basic signal and the additional signal being added upstream or downstream of the bridge circuit.

14. The system of claim 10, further comprising a sensor operatively connected to a component of a device for monitoring an operating parameter of the component, wherein, when the operating parameter has a value that indicates the presence of a defined operating state of the component, the system is configured to generate the pulse-width-modulated basic signal having a pulse width modulation frequency, generate a sinusoidal additional signal at a sinusoidal frequency in an acoustically audible frequency range, add the basic signal and the additional signal to form an acoustic signal for the electric variable, and make the electric variable with the acoustic signal available to the electric motor.
